(19) United States
(12) Patent Application Publication
(10) Pub. No.: US 2023/0388363 A1
(43) Pub. Date: Nov. 30, 2023

(54) INFORMATION PROCESSING APPARATUS AND CONTROL METHOD THEREOF, AND STORAGE MEDIUM

(71) Applicant: Canon Kabushiki Kaisha, Tokyo (JP)

(72) Inventor: KEI OGAWA, Tokyo (JP)

(21) Appl. No.: 18/319,529

(22) Filed: May 18, 2023

(30) Foreign Application Priority Data
May 31, 2022 (JP) 2022-088878

(51) Int. Cl. H04L 67/025; H04N 1/00

(52) U.S. Cl. CPC H04L 67/025; H04N 1/00464

(57) ABSTRACT

An information processing apparatus is capable of communicating with a server that provides a website for managing a specific device and with a system for providing information obtained by monitoring a plurality of devices including the specific device. The apparatus displays, in a display unit, the website provided by the server, and obtains, from the system, a display program for displaying the information provided by the system on the website. The apparatus obtains, by the display program, information on the specific device from the system using data which is data for accessing information on devices and which is data corresponding to a user who is logged into the website, and displays, by the display program, the information on the specific device in a predetermined screen that is a part of the website.

### BACKGROUND OF THE INVENTION

### Field of the Invention

The present invention relates to an information processing apparatus, a control method thereof, and a storage medium.

### Description of the Related Art

In devices such as image forming apparatuses, the management of consumables in the device, inquiries made when a failure occurs, and the like are performed by the user (administrator) who manages the device. To this end, a website for an administrator to manage the device can be provided for customers using the device. Such a website is constituted, for example, by customer information managed by the company that provides the website (called a “site management company” hereinafter) and device information managed by the manufacturer that manufactures the device. In this case, the site management company connects with, for example, an external server managed by the manufacturer to access the external server and obtain the device information.

For example, Japanese Patent Laid-Open No. 2018-66811 describes a technique in which a WWW server is run in a management server that manages device information, and the device information managed by the management server is provided from the WWW server to a web browser in a user PC of a sales company.

With the conventional technique described above, it is necessary for the site management company to obtain and process the device information obtained from the server managed by the device manufacturer, and display the processed device information on the website. This places a heavy burden on the site management company for implementing the website. In addition, to improve convenience for users, it is necessary to be able to more efficiently display, in the screens of the website, the customer information managed by the server of the site management company and the device information obtained from the server managed by the manufacturer.

### SUMMARY OF THE INVENTION

Accordingly, the present disclosure provides a technique that enables efficient display of information obtained from a plurality of servers while lightening the burden of implementing a website for managing devices.

According to one aspect of the present invention, there is provided an information processing apparatus capable of communicating with a server that provides a website for managing a specific device and with a system for providing information obtained by monitoring a plurality of devices including the specific device, the information processing apparatus comprising: a first display unit configured to display, in a display unit of the information processing apparatus, the website provided by the server; a first obtaining unit configured to obtain, from the system, a display program for displaying the information provided by the system on the website; a second obtaining unit configured to obtain, by the display program, information on the specific device from the system using data which is data for accessing information on devices and which is data corresponding to a user who is logged into the website; and a second display unit configured to display, by the display program, the information on the specific device in a predetermined screen that is a part of the website.

According to another aspect of the present invention, there is provided a control method of an information processing apparatus capable of communicating with a server that provides a website for managing a specific device and with a system for providing information obtained by monitoring a plurality of devices including the specific device, the control method comprising: displaying, in a display unit of the information processing apparatus, the website provided by the server; obtaining, from the system, a display program for displaying the information provided by the system on the website; obtaining, by the display program, information on the specific device from the system using data which is data for accessing information on devices and which is data corresponding to a user who is logged into the website; and displaying, by the display program, the information on the specific device in a predetermined screen that is a part of the website.

According to still another aspect of the present invention, there is provided a computer-readable storage medium storing a program for causing a computer to execute a control method of an information processing apparatus capable of communicating with a server that provides a website for managing a specific device and with a system for providing information obtained by monitoring a plurality of devices including the specific device, the control method comprising: displaying, in a display unit of the information processing apparatus, the website provided by the server; obtaining, from the system, a display program for displaying the information provided by the system on the website; obtaining, by the display program, information on the specific device from the system using data which is data for accessing information on devices and which is data corresponding to a user who is logged into the website; and displaying, by the display program, the information on the specific device in a predetermined screen that is a part of the website.

Further features of the present invention will become apparent from the following description of exemplary embodiments (with reference to the attached drawings).

### BRIEF DESCRIPTION OF THE DRAWINGS

FIG. 1 is a diagram illustrating an example of the overall configuration of a system.

FIG. 2 is a block diagram illustrating an example of the hardware configuration of an information processing apparatus.

FIG. 3 is a block diagram illustrating an example of the functional configuration of a system.

FIG. 4 is a block diagram illustrating an example of the functional configuration of the system.

FIG. 5 is a sequence chart illustrating an example of a sequence of processing for displaying a UI screen of a website provided by a customer information management server in an information terminal.

FIG. 6 is a flowchart illustrating an example of the sequence of processing for determining display information for a UI object (step S515).

FIGS. 7A and 7B illustrate a device list screen as an example of a UI screen in a website.

FIG. 8 is a flowchart illustrating an example of the sequence of processing for determining display information for a UI object (step S515).

FIG. 9 illustrates a device details screen as an example of a UI screen in a website.

FIG. 10 is a flowchart illustrating an example of the sequence of processing for determining display information for a UI object (step S515).

FIG. 11 illustrates a device details screen indicating a device inspection history, as an example of a UI screen in a website.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

<System Configuration>

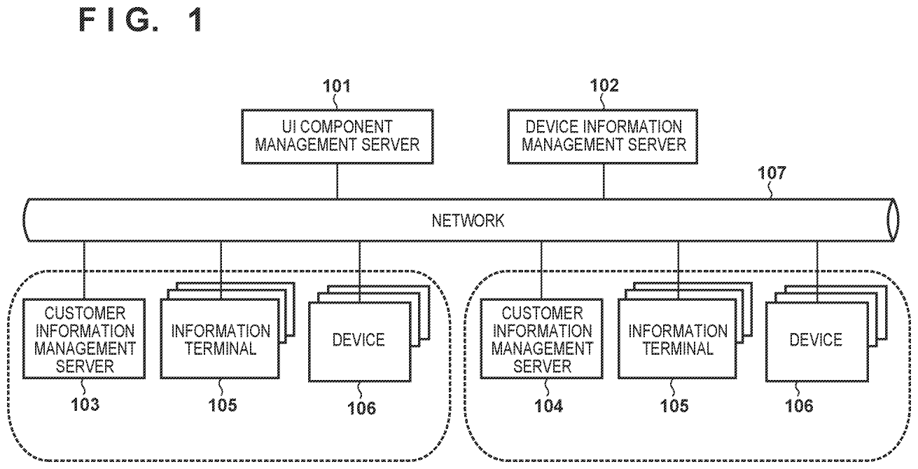

FIG. 1 illustrates an example of the overall configuration of a system according to a first embodiment of the present disclosure. This system includes a UI component management server 101, a device information management server 102, customer information management servers 103 and 104, an information terminal 105, and a device 106. Note that in addition to the servers 101 to 104 illustrated in FIG. 1, the system may also include other servers (not shown) that provide other functions.

The UI component management server 101 is a server that provides UI components and manages, on an application-by-application basis, source code for generating UI components on a website. Note that the website is generated from source code written in HTML, Cascading Style Sheets (CSS), JavaScript °, or the like. CSS is a style sheet language, and JavaScript is a programming language for writing programs that run in a web browser. The UI components are generated from source code written in JavaScript. The UI component management server 101 accepts requests from websites managed by the customer information management servers 103 and 104 (websites provided by the customer information management servers 103 and 104 to the information terminal 105 and run in a web browser). The UI component management server 101 provides the source code for the UI components in response to the accepted requests.

The device information management server 102 is a server that provides information obtained by monitoring the status of at least one device 106 to be managed, and receives and manages the device information from the at least one device 106. In the present embodiment, the device information includes information such as, for example, basic information on the device (product name and serial number), operational information (consumable information such as toner remaining amount information, alert information, and security information), and the like. The device information management server 102 accepts requests from UI components operating on the website and provides device information in response to the accepted requests. As described above, the UI components are generated on a website based on source code provided by the UI component management server 101. Note that if information is managed by different servers according to the type of information to be provided (e.g., the basic information, the operational information, manual information, and the like), the device information management server 102 may be configured to provide information managed by at least one server in response to a request from a UI component.

The customer information management server 103 is a server that provides a website for managing at least one device 106. The customer information management server 103 manages customer information provided to the information terminal 105. In the present embodiment, the customer information includes, for example, user authentication information and management information for each device (e.g., a device name, an installation location, and a serial number). The customer information management server 103 also manages a website which is provided for customers using the device 106 and which can be used to manage the device 106. The customer information management server 103 provides a website to the information terminal 105 in response to a request from (a web browser running on) the information terminal 105. The website provided to the information terminal 105 runs on the web browser provided in the information terminal 105. The website makes a request to the UI component management server 101 for the source code for generating the UI components to run on the website. A configuration in which the customer information and websites managed by the customer information management server 103 are managed by different servers may be employed.

The customer information management server 104 has the same configuration as the customer information management server 103, but manages different customers from those managed by the customer information management server 103. Accordingly, the customer information management server 104 manages customer information and websites independent from the customer information management server 103. The customer information management servers 103 and 104 may be configured to manage websites that use common UI components.

The information terminal 105 is a terminal device operated by a user, and is constituted by a personal computer (PC) or smartphone, for example. The information terminal 105 has a web browser, which can be used by the user to operate websites. The information terminal 105 makes requests to obtain websites managed by the customer information management servers 103 and 104 through the web browser. The web browser obtains the source code of the websites from the customer information management servers 103 and 104 and generates the websites based on the obtained source code. The generated websites can be operated by the user by running on the web browser. Note that the system illustrated in FIG. 1 may have at least two information terminals for each customer managed by the customer information management servers 103 and 104.

The device 106 is a device managed by the user using the information terminal 105. The device 106 is constituted by a device such as a PC, a smartphone, a multifunction peripheral, a facsimile (FAX) machine, a printer, a camera, or the like, and has a function for connecting to a network 107. The information terminal 105 actively transmits information related to the device 106 to the device information management server 102. The device information management server 102 stores and manages the information received from the information terminal 105. Note that the system illustrated in FIG. 1 may have at least two devices for each customer managed by the customer information management servers 103 and 104.

The UI component management server 101, the device information management server 102, the customer information management servers 103 and 104, the information terminal 105, and the device 106 are communicatively connected to each other over the network 107. The network 107 includes, for example, communication networks such as the Internet, a Wide Area Network (WAN), a Local Area Network (LAN), or the like. In addition to the above, the network 107 may include at least one of a telephone line, a dedicated digital line, an asynchronous transfer mode (ATM) or frame relay line, a cable television line, a wireless line for data broadcasting, or the like. The network 107 may also include a mobile network that supports a mobile communication standard such as Long Term Evolution (LTE) and 5th Generation (5G) NR (New Radio).

In the present embodiment, the information terminal 105 is an example of an information processing apparatus capable of communicating with the customer information management server 103 or 104 (a first server), the device information management server 102 (a second server), and the UI component management server 101 (a third server). The customer information management server 103 or 104 is an example of a first server that provides a website for managing the at least one device 106. The device information management server 102 is an example of a second server that provides information obtained by monitoring the status of the at least one device 106. The UI component management server 101 is an example of a third server that provides UI components.

<Hardware Configuration of Information Processing Apparatus>

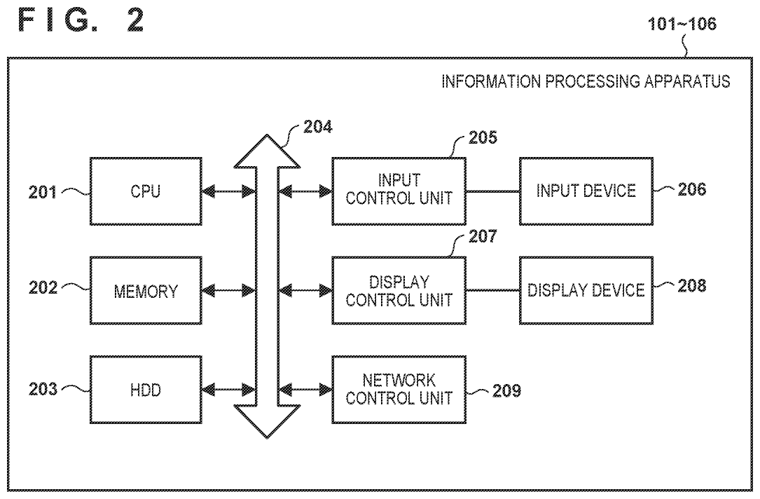

FIG. 2 is a block diagram illustrating an example of the hardware configuration of the information processing apparatus. Each of the servers 101 to 105 and the device 106 illustrated in FIG. 1 can be configured as the information processing apparatus illustrated in FIG. 2. The information processing apparatus includes a central processing unit (CPU) 201, a memory 202, a hard disk drive (HDD) 203, an input control unit 205, an input device 206, a display control unit 207, a display device 208, and a network control unit 209. The information processing apparatus includes the HDD 203 as a non-volatile storage device, but may include another type of storage device (e.g., a solid state drive (SSD)) instead of the HDD 203 or in addition to the HDD 203.

The CPU 201 controls each hardware device connected to a system bus 204 by reading and executing programs (software) stored in the HDD 203. The memory 202 is a volatile storage device that functions as a main memory and working area for the CPU 201. Various programs and various data are stored in the HDD 203.

The input control unit 205 controls inputs from the input device 206. The input device 206 is constituted by a keyboard and a touch panel, for example. The display control unit 207 controls displays made by the display device 208. The display control unit 207 is constituted by a liquid crystal display, for example. Depending on the role of the information processing apparatus, there may be configurations where the input control unit 205 and the input device 206 are not present. Additionally, depending on the role of the information processing apparatus, there may be configurations where the display control unit 207 and the display device 208 are not present. The network control unit 209 is a communication interface for communicating with external devices over the network 107.

In the present embodiment, the UI component management server 101 and the device information management server 102 are realized by an information processing apparatus provided as a cloud computing service. Cloud computing includes serverless computing, virtual machines, or the like. Although a single hardware resource is illustrated in FIG. 2, a plurality of hardware resources may be used in cloud computing. The UI component management server 101 and the device information management server 102 may each be realized by a single physical machine or a plurality of physical machines.

<Functional Configuration>

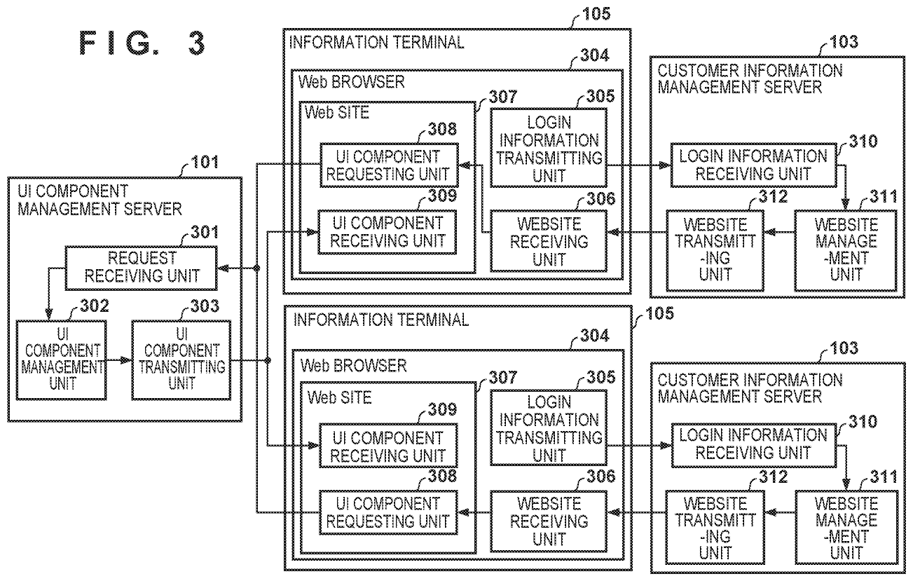

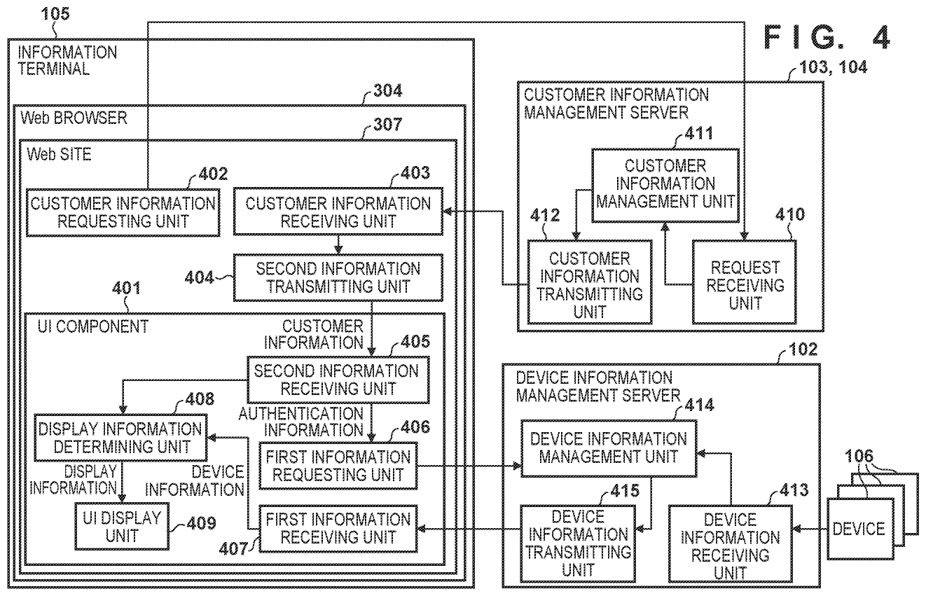

FIGS. 3 and 4 are block diagrams illustrating an example of the functional configuration of the system according to the present embodiment. An example of the functional configuration related to a series of processing from processing for logging in to the website provided by the customer information management server 103 to processing for generating UI components by the information terminal 105 will be described first with reference to FIG. 3.

Information Terminal 105

The information terminal 105 includes a web browser 304 as one application running on that information terminal. The web browser 304 includes a login information transmitting unit 305 and a website receiving unit 306.

The login information transmitting unit 305 transmits login information for accessing the website to the customer information management server 103 or 104 over the network 107. The website receiving unit 306 receives source code for generating a website that runs on the web browser 304 from the customer information management server 103 or 104. Based on the received source code, the website receiving unit 306 generates a website 307 that runs on the web browser 304. The generated website 307 includes a UI component requesting unit 308 and a UI component receiving unit 309.

The UI component requesting unit 308 requests UI components having application functions required by the website 307 from the UI component management server 101 over the network 107. The request for the UI components is realized, for example, by providing a description in the source code (HTML code) of the website 307 for loading the source code (JavaScript code) of the UI components. The following is an example of the content of a part of the HTML code, in which a URL which is for loading the JavaScript code of a UI component and which indicates where the source code of the UI component is saved is written using the script tag.

<script src=”https://ui-parts.server/bundle.js”> </script>

In the above example, “https://ui-parts.server” is the URL indicating the UI component management server 101. “https://ui-parts.server/bundle.js” indicates a JavaScript file in which the source code (JavaScript code) of the UI components is written. The UI component requesting unit 308 makes a request for the UI components (the source code of the UI components) to the UI component management server 101 according to the above-described descriptions in the source code of the website 307.

The UI component receiving unit 309 receives the source code of UI components transmitted from the UI component management server 101 in response to the request from the UI component requesting unit 308, and generates the UI components using the received source code. The generation of UI components is realized, for example, by providing a description in the source code (the HTML code) of the website 307 using original HTML tags (proprietary HTML tags) that indicate generation of the UI components. The following is an example of the description of part of the HTML code, and is an example of the original HTML tag indicating the generation of the UI components.

```
<ui-parts
  name = “device name”
  serial = “serial number”
  token = “authentication information”
> ... </ui-parts>
```

Even if the website 307 provided by the customer information management server 103 is different from the website 307 provided by the customer information management server 104, the UI component management server 101 provides common UI components to each website.

Customer Information Management Servers 103 and 104

The customer information management server 103 includes a login information receiving unit 310, a website management unit 311, and a website transmitting unit 312. The customer information management server 104 has the same configuration as the customer information management server 103.

The login information receiving unit 310 receives login information from the login information transmitting unit 305 of the web browser 304 and performs user authentication (authentication regarding whether or not the user can access the website) based on the received login information. If the user authentication is successful (i.e., the user can access the website), the login information receiving unit 310 notifies the website management unit 311 of access information indicating that the user is allowed to access the website.

The website management unit 311 manages the source code for generating a website for a customer using the device 106. Upon receiving the access information from the login information receiving unit 310, the website management unit 311 notifies the website transmitting unit 312 of the source code for generating the website for the customer corresponding to the access information. Upon receiving the notification of the source code from the website management unit 311, the website transmitting unit 312 delivers (transmits) the source code for which the notification was made to the website receiving unit 306 of the web browser 304 from which the login information was transmitted. The source code of the website is delivered from a URL for delivery through a Content Delivery Network (CDN).

The UI component management server 101 includes a request receiving unit 301, a UI component management unit 302, and a UI component transmitting unit 303. The request receiving unit 301 receives a request for a UI component from the web browser 304 (the information terminal 105). Based on the received request, the request receiving unit 301 notifies the UI component management unit 302 of component information indicating the requested UI component.

The UI component management unit 302 manages the source code for generating UI components for each application. Upon receiving the notification from the request receiving unit 301, the UI component management unit 302 notifies the UI component transmitting unit 303 of the source code corresponding to the component information for which the notification was made (the source code for generating the UI component indicated by the component information). The source code for UI components is written in JavaScript and created using Web Components. Web Components is a technology that can be used in any website construction environment and is used to create custom components that can be embedded in web pages or web applications and can be reused.

Upon receiving a notification of the source code from the UI component management unit 302, the UI component transmitting unit 303 delivers (transmits) the source code for which the notification was made to the website 307 which requested the UI component. The source code of the UI components is delivered from a URL for delivery through a CDN.

An example of the functional configuration related to a series of processing performed by the information terminal 105, from the processing for generating a UI component on a website running on a web browser to processing for displaying information obtained from the device information management server 102, will be described next with reference to FIG. 4.

Information Terminal 105

In this configuration example, the website 307 is generated in the web browser 304 of the information terminal 105 using source code provided by the customer information management server 103 or 104. In the generated website 307, a UI component 401 is generated based on the source code provided by the UI component management server 101. The generated website 307 includes the UI component 401, a customer information requesting unit 402, a customer information receiving unit 403, and a second information transmitting unit 404. The UI component 401 includes a second information receiving unit 405, a first information requesting unit 406, a first information receiving unit 407, a display information determining unit 408, and a UI display unit 409. UI screens of the generated website 307 are displayed in the display device 208 by the web browser 304.

The customer information requesting unit 402 requests customer information of the user logged into the website 307 from the customer information management server 103 or 104 over the network 107. The customer information receiving unit 403 receives the customer information from the customer information management server 103 or 104 and notifies the second information transmitting unit 404 of the received customer information. Upon receiving the notification of the customer information from the customer information receiving unit 403, the second information transmitting unit 404 notifies the UI component 401 (the second information receiving unit 405) of the customer information, among the customer information for which the notification was made, which is required to use the UI component 401 (necessary information). The customer information required to use the UI component includes, for example, the user authentication information (e.g., an access token), management information for each device (e.g., the device name, installation location, and serial number), and the like. The authentication information can be used by the UI component 401 to obtain the device information from the device information management server 102.

The notification (input) of the customer information from the second information transmitting unit 404 to the UI component 401 (the second information receiving unit 405) is realized, for example, using attributes of the original HTML tag indicating the generation of the UI component. The following is an example of the description of part of the HTML code, in which a name attribute, a serial attribute, and a token attribute are written as attributes of the original HTML tag indicating the generation of the UI component.

```
<ui-parts″
  name = “device name”
  serial = “serial number”
  token = “authentication information”
> ... </ui-parts>
```

In the above example, the name attribute, the serial attribute, and the token attribute are given the device name, the serial number, and the authentication information as attribute values (parameter values), respectively. In this manner, the UI component 401 can be notified of the customer information from the website 307 by writing the customer information as attribute values (parameter values) incorporated into attributes of the original HTML tag indicating the generation of the UI component.

Upon receiving the customer information from the second information transmitting unit 404, the second information receiving unit 405 of the UI component 401 determines whether the received customer information is information having a structure predefined in the UI component 401. Here, the second information receiving unit 405 determines whether the information incorporated into the attributes of the original HTML tag indicating the generation of the UI component, which is written in the source code (the HTML code) of the website 307, is information having a predefined structure. If the received customer information has a predefined structure, the second information receiving unit 405 notifies the first information requesting unit 406 of the authentication information among the information contained in the customer information, and notifies the display information determining unit 408 of the remaining information.

The first information requesting unit 406 receives the authentication information from the second information receiving unit 405. This authentication information is used to determine whether the device information can be obtained from the device information management server 102, and is constituted by an access token, for example. The first information requesting unit 406 makes a request for the device information to the device information management server 102. Specifically, the first information requesting unit 406 sends a request for the device information, including the received authentication information, to the device information management server 102 over the network 107. An Application Programming Interface (API) is used to transmit the device information request.

The first information receiving unit 407 receives, from the device information management server 102 (a device information transmitting unit 415), the device information requested of the device information management server 102 by the first information requesting unit 406. The first information receiving unit 407 notifies the display information determining unit 408 of the received device information.

The display information determining unit 408 receives the customer information from the second information receiving unit 405 and the device information from the first information receiving unit 407. The display information determining unit 408 performs determination processing to determine the display information to be displayed in the UI object corresponding to the UI component 401 based on the received customer information and device information. The display information determining unit 408 notifies the UI display unit 409 of the determined display information.

For example, the display information determining unit 408 identifies information corresponding to the same device by comparing the information for each device contained in the customer information with the information for each device contained in the device information and identifying information containing the same serial number. The display information determining unit 408 further determines the display information to be displayed on the UI object corresponding to the UI component 401 by associating the information corresponding to the same device contained in the customer information and the device information, respectively, and notifies the UI display unit 409 of that display information. On the other hand, the display information determining unit 408 does not notify the UI display unit 409 of the information, contained in the device information, that is not associated with the customer information, as the display information.

According to this display information determination processing, only the information, among the device information obtained from the device information management server 102, that is associated with the customer information which the UI component 401 is notified of from the website 307, is displayed by the UI component 401. Accordingly, for example, the website 307 notifies the UI component 401 (the second information receiving unit 405) of the customer information filtered using specific device names, which enables the UI component 401 to narrow down the device information to be displayed on the UI object.

The UI display unit 409 displays the display information for which the display information determining unit 408 made the notification on the UI object corresponding to the UI component 401. Note that the UI object corresponding to the UI component 401 is displayed on the UI screen of the website 307.

Customer Information Management Servers 103 and 104

The customer information management servers 103 and 104 include a request receiving unit 410, a customer information management unit 411, and a customer information transmitting unit 412.

The request receiving unit 410 receives the request for the customer information from the website 307 (the customer information requesting unit 402) running on the web browser 304 of the information terminal 105 and notifies the customer information management unit 411 of the received request. The customer information management unit 411 manages the customer information provided to the website 307. Upon receiving a request for customer information from the request receiving unit 410, the customer information management unit 411 collects customer information for use on the website 307 from the managed customer information based on the received request. The customer information management unit 411 notifies the customer information transmitting unit 412 of the collected information. The customer information transmitting unit 412 transmits the customer information for which the customer information management unit 411 made the notification to the website 307 (the customer information receiving unit 403) over the network 107 as a response to the request for the customer information.

Device Information Management Server 102

The device information management server 102 includes a device information receiving unit 413, a device information management unit 414, and the device information transmitting unit 415.

The device information receiving unit 413 receives the device information transmitted from the device 106 and notifies the device information management unit 414 of the received device information. The device information transmitted from the device 106 includes, for example, basic information on the device (product name and serial number), operational information (consumable information such as toner remaining amount information, alert information, and security information), and the like.

The device information management unit 414 receives the device information from the device information receiving unit 413 and manages the received device information in association with the user authentication information. Upon receiving a request for the device information from the UI component 401 (the first information requesting unit 406), the device information management unit 414 identifies the device information, among the managed device information, that is associated with the authentication information included in the received request. The device information management unit 414 transmits the identified device information to the device information transmitting unit 415.

The device information transmitting unit 415 transmits the device information received from the device information management unit 414 to the UI component 401 (the first information receiving unit 407) over the network 107 as a response to the request for the device information. An API is used to transmit the device information.

<Processing Sequence>

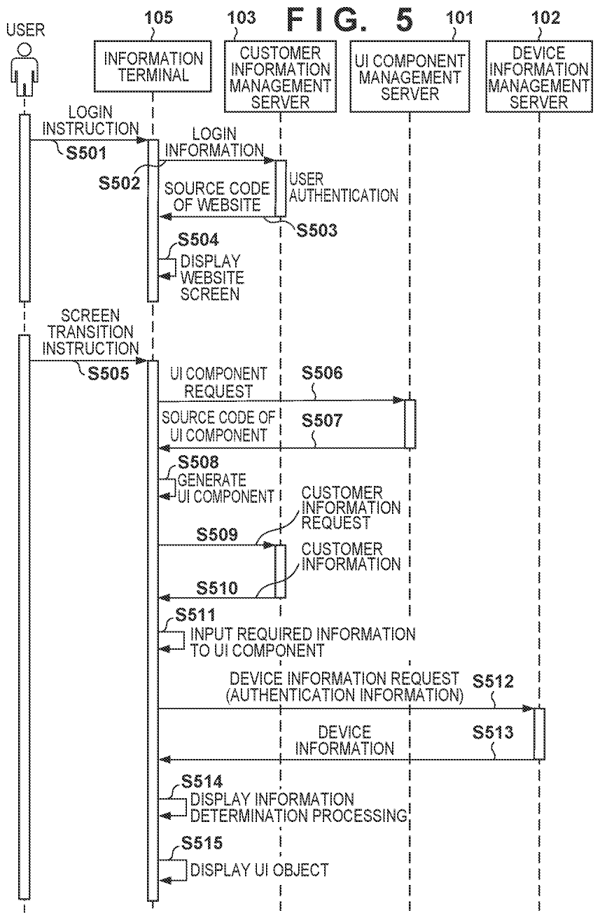

FIG. 5 is a sequence chart illustrating an example of a sequence of processing for displaying, in the information terminal 105, a UI screen of the website 307 provided by the customer information management server 103, in the system according to the present embodiment. Each process in the information terminal 105 is realized as processing performed by the CPU 201 by the CPU 201 reading out and executing a program stored in the memory 202 or the HDD 203 of the information terminal 105.

In this processing, the information terminal 105 incorporates the UI component 401 provided by the UI component management server 101 into the website 307 provided by the customer information management server 103. The information terminal 105 further controls the display of the UI object corresponding to the UI component 401 in the UI screen of the website 307 based on the customer information and device information obtained from the customer information management server 103 and the device information management server 102, respectively.

The following will describe an example of displaying a device list screen, showing a list of the devices 106 (a device list) owned by customers, in response to user operations made through the web browser 304, as a UI screen of the website 307. An example of display control that displays the device list as a UI object corresponding to the UI component 401 in that device list screen will be described here. This example will describe a case where of the customer information management servers 103 and 104, the customer information management server 103 is used, but the same applies when the customer information management server 104 is used.

In step S501, the information terminal 105 accepts a user operation for instructing a login to the website 307 provided by the customer information management server 103, through the web browser 304. The login instruction is made, for example, using the input device 206 of the information terminal 105, through the login screen displayed in the display device 208 by the web browser 304. The login screen is configured to accept the input of a user ID and a password as the login information.

When a user operation for the login instructions is made, in step S502, the information terminal 105 (the web browser 304) transmits the login information input by the user through the login screen to the customer information management server 103 for user authentication. The customer information management server 103 performs user authentication based on the login information received from the information terminal 105, and if the user authentication is successful, transmits the source code of the website 307 for the customer who has been authenticated to the information terminal 105.

As a result, in step S503, the information terminal 105 (the web browser 304) obtains the source code of the website 307 from the customer information management server 103. In step S504, the information terminal 105 generates the website 307 using the source code obtained in step S503, and displays a UI screen of the website 307 (a website screen) in the browser screen of the web browser 304. In this manner, the web browser 304 displays the UI screen of the website 307 in the display device 208 (a display unit) of the information terminal 105 based on the login to the website 307 provided by the customer information management server 103.

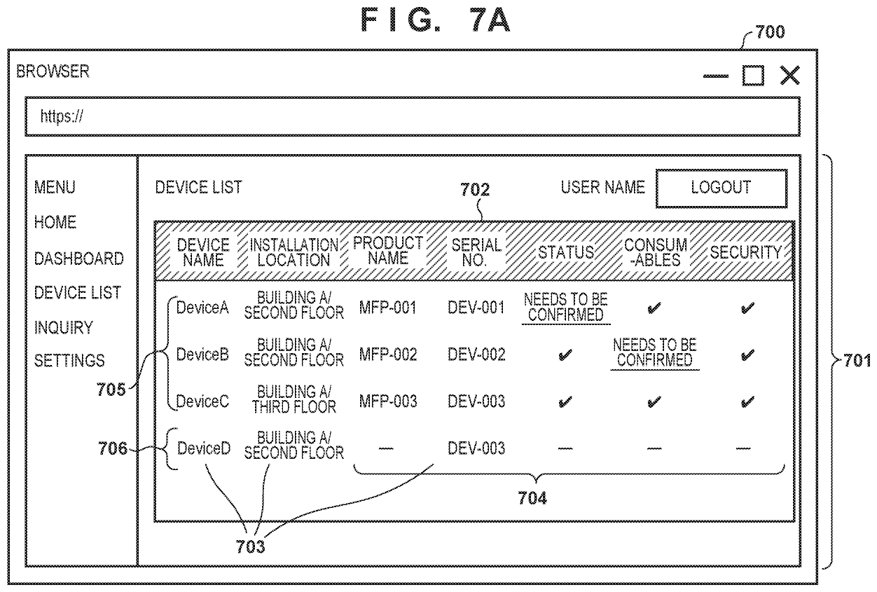

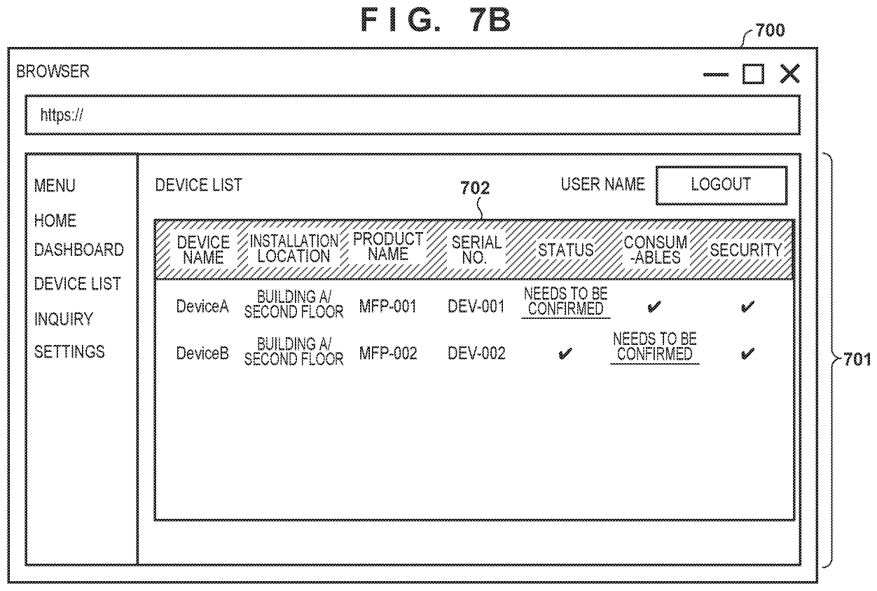

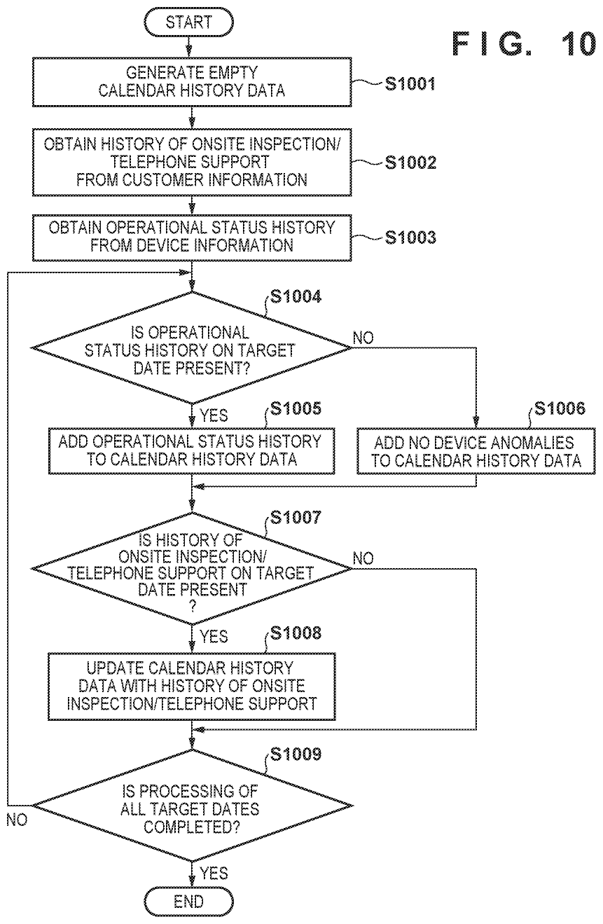

Then, in step S505, the information terminal 105 (the web browser 304) accepts a user operation instructing a specific screen to be displayed (a screen transition to a specific screen) as the UI screen of the website 307 through the website screen displayed in the information terminal 105. As described above, this example describes a case where an instruction to transition the screen to the device list screen as illustrated in FIGS. 7A and 7B is made by the user. (Note that a second embodiment will describe a case where an instruction to transition the screen to a device details screen as illustrated in FIG. 10 is made by the user.)

In response to the user operation for instructing the screen to transition to the device list screen, in step S506, the information terminal 105 (the web browser 304) makes a request to the UI component management server 101 for a UI component for displaying the device list. Upon receiving the request for the UI component from the web browser 304, the UI component management server 101 transmits the source code of the UI component, among the UI components which are managed, that has been requested to the web browser 304 as a response to the received request.

As a result, in step S507, the information terminal 105 (the web browser 304) obtains the source code of the UI component for displaying the device list from the UI component management server 101. In this manner, in response to a user operation that instructs the device list screen (a first screen) to be displayed as the UI screen of the website 307, the web browser 304 makes a request to the UI component management server 101 for the UI component that displays UI objects in the device list screen. The web browser 304 obtains the UI component from the UI component management server 101 as a response to this request.

Next, in step S508, the information terminal 105 (the web browser 304) generates the UI component 401 for displaying the device list using the source code obtained in step S507. As described above, the generation of the UI component 401 is performed according to the original HTML tags in the source code of the website 307 that indicate the generation of the UI component (e.g., <ui-parts> . . . </ui-parts>). The generated UI component 401 runs in the web browser 304 (the website 307).

When the generation of the UI component 401 is complete, in step S509, the information terminal 105 (the web browser 304) makes a request to the customer information management server 103 for the customer information of the user logged into the website 307, which is managed by the customer information management server 103. Upon receiving the request for the customer information from the web browser 304, the customer information management server 103 transmits the requested customer information (the customer information of the user logged into the website 307) to the web browser 304 as a response to the received request.

As a result, in step S510, the information terminal 105 (the web browser 304) obtains the customer information corresponding to the user logged into the website 307 from the customer information management server 103 for notifying (inputting to) the UI component 401. The customer information obtained from the customer information management server 103 includes the user's authentication information (in this example, an access token) and the management information for each device (in this example, the device name, the installation location, and the serial number).

When the obtainment of the customer information is completed, in step S511, the information terminal 105 (the web browser 304) notifies (inputs) the UI component 401 of the customer information required to use the UI component 401 (the necessary information), from among the obtained customer information. As described above, notifying the UI component 401 of the necessary information (inputting the necessary information) is realized, for example, by incorporating the necessary information into the attributes (e.g., the name attribute, the serial attribute, and the token attribute) of the original HTML tags, in the source code of the website 307, that indicate the generation of the UI components (e.g., <ui-parts> . . . </ui-parts>). For example, the UI component 401 is notified of the user's authentication information (access token) and the management information for each device (the device name, the installation location, and the serial number) from the website 307.

Next, in step S512 to step S515, the web browser 304 displays the device list screen (the first screen) including the UI objects displayed by the UI component 401 in the display device 208 (the display unit). The processing from step S512 to step S515 is executed by the UI component 401 running on the web browser 304 (the website 307) in the information terminal 105.

In step S512, the UI component 401 transmits a request for device information to the device information management server 102 in response to the notification (input) of the necessary information to the UI component 401. The request for the device information includes an access token of which the UI component 401 is notified by the website 307. The use of an access token enables the device information to be obtained from the device information management server 102 without accepting the input of the user's login information (user ID and password).

Upon receiving the request for the device information, the device information management server 102 transmits the device information, among the device information which is managed, that is associated with the authentication information (the access token) included in the received request, as a response to the request. As a result, in step S513, the UI component 401 obtains the device information from the device information management server 102. Note that the device information transmitted from the device information management server 102 includes, for example, the basic information on the device (product name and serial number) and the operational information (consumable information such as toner remaining amount information, alert information, and security information). In this manner, the UI component 401 is configured to make a request to the device information management server 102 for the device information provided by the device information management server 102, and to obtain that device information from the device information management server 102.

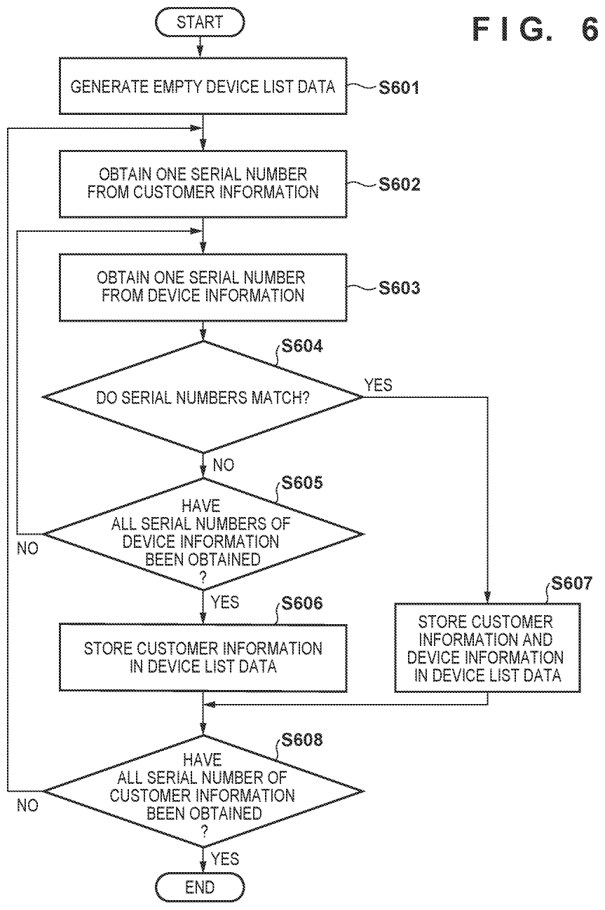

Then, in step S514, the UI component 401 performs the display information determination processing for the UI object corresponding to the UI component 401 to be displayed in the UI screen (the website screen) of the website 307. Specifically, the UI component 401 determines the information to be displayed on the UI object based on the customer information notified (input) from the website 307 and the device information obtained from the device information management server 102. Note that in the present embodiment, the processing of step S514 is executed according to the procedure in FIG. 6 (described later). Then, in step S515, the UI component 401 displays a UI object including the determined display information in the UI screen (the website screen) of the website 307. In this manner, the UI component 401 is configured to control the display of one piece of information, among the customer information obtained from the customer information management server 103 (first information) and the device information (second information) obtained from the device information management server 102 (the second server), based on the other piece of information, in the corresponding UI object.

<Display Information Determination Processing (Step S515)>

FIG. 6 is a flowchart illustrating an example of the sequence of the processing for determining display information for a UI object in the present embodiment (step S515). The processing in this sequence is executed by the UI component 401 for displaying the device list running on the web browser 304 (the website 307) in the information terminal 105. The UI component 401 (the display information determining unit 408) performs the display information determination processing based on the customer information notified (input) from the website 307 and the device information obtained from the device information management server 102.

In step S601, the UI component 401 generates empty device list data for storing the information to be displayed on the corresponding UI object (the display information). As an example, the device list data is generated as data, in list format, for each device, for storing the device name, installation location, product name, serial number, alert information, consumable information (e.g., toner remaining amount information), and security information. In this manner, the device list data is configured to be capable of storing information obtained from the customer information and the device information.

Next, in step S602, the UI component 401 obtains the serial numbers contained in the customer information one by one, after which the sequence moves to step S603. In this example, the customer information includes the authentication information (the access token) and the management information for each device managed by the customer. The management information for each device is constituted by data, in list format, that stores the device name, installation location, and serial number for each device. The UI component 401 obtains the serial number of at least one device, one by one, from the customer information.

In step S603 to step S607, the UI component 401 refers to the serial numbers contained in the device information one by one and associates the customer information with the device information based on a result of comparison with the serial number obtained from the customer information in step S602.

First, in step S603, the UI component 401 obtains the serial numbers contained in the device information one by one, after which the sequence moves to step S604. In this example, the device information is constituted by data, in list format, including the product name, serial number, alert information, consumable information (e.g., toner remaining amount information), and security information for each device already registered in the device information management server 102. The UI component 401 obtains the serial number of at least one device, one by one, from the device information.

In step S604, the UI component 401 compares the serial number obtained from the customer information with the serial number obtained from the device information, and determines whether those serial numbers match. The UI component 401 moves the sequence to step S605 if the serial numbers do not match, and moves the sequence to step S607 if the serial numbers do match.

In step S607, the UI component 401 associates the corresponding customer information (device name and installation location) and device information (product name, alert information, consumable information, and security information) based on the matching serial numbers, and stores that information in the device list data. That is, the UI component 401 stores the customer information and the device information associated with the device having the same serial number. The UI component 401 then moves the sequence to step S608.

In step S605, the UI component 401 determines whether all the serial numbers included in the device information have been referenced. If there is still a serial number, among the serial numbers included in the device information, which has not yet been reference (i.e., a serial number that has not been compared with the serial number obtained from the customer information), the UI component 401 returns the sequence to step S603. Through this, the UI component 401 obtains the serial numbers included in the device information in sequence (step S603) and compares those serial numbers with the serial number obtained from the customer information (step S604).

On the other hand, if in step S605 all the serial numbers in the device information have been referenced (i.e., no serial number matching the serial number obtained from the customer information was present in the device information), the UI component 401 moves the sequence to step S606. In step S606, the UI component 401 stores the customer information for the device corresponding to the serial number obtained in step S602 in the device list data, after which the sequence moves to step S608.

In this manner, for each serial number included in the customer information, obtained in step S602, an evaluation is made as to whether the same serial number is included in the device information (step S604). If the same serial number is included in the device information, the customer information and device information corresponding to the same serial number are associated and stored in the device list data as the display information to be displayed on the UI object corresponding to the UI component 401.

In step S608, the UI component 401 determines whether all the serial numbers included in the customer information have been referenced. If all the serial numbers included in the customer information have been referenced, the UI component 401 ends the display information determination processing. On the other hand, if there is a serial number, among the serial numbers included in the customer information, that has not been referenced (i.e., there is still a serial number for which the evaluation of whether the same serial number is included in the device information has not been completed), the UI component 401 returns the sequence to step S602. Through this, the UI component 401 obtains the serial numbers included in the customer information in sequence (step S602) and compares those serial numbers with each serial number included in the device information (step S604 to step S606).

Through the above-described processing, the UI component 401 determines the display information for the UI object and generates the device list data including the determined display information (step S514). The UI component 401 displays the device list on the UI object corresponding to the UI component 401 based on the generated device list data (step S515). In this manner, the UI component 401 associates information corresponding to the same serial number as the serial number of the device, which is included in both the customer information and the device information. The UI component 401 further controls whether only the customer information, or both the customer information and the device information, is displayed in the device list, for each device, in accordance with the stated association.

According to this processing, for the device information, only the device information associated with the customer information is displayed in the UI object (device list) corresponding to the UI component 401. Accordingly, for example, by notifying the UI component 401 of only a specific serial number as the customer information in step S511, it is possible to display only the device information corresponding to that serial number on the UI object corresponding to the UI component 401. In other words, based on the customer information the UI component 401 is notified of by the website 307, the device information displayed by the UI component 401 on the UI object can be filtered (that is, the device information to be displayed on the UI object can be narrowed down).

### Example of Display of Device List Screen

FIGS. 7B and 7B illustrate a device list screen 701 as an example of the UI screen of the website 307 displayed by the web browser 304 in the information terminal 105. The device list screen 701 is displayed in a browser screen 700 of the web browser 304.

The web browser 304 accepts an instruction to display the device list screen (an instruction to transition to the device list screen) from the user through, for example, a UI screen (e.g., a menu screen) of the website 307. The web browser 304 displays the device list screen 701 in the browser screen 700, including a UI object 702 indicating the device list, in accordance with the instruction to display the device list screen.

The UI object 702 is a display object displayed by the UI component 401 for displaying the device list. The UI component 401 to be implemented in the website 307 is generated based on the source code obtained from the UI component management server 101, and the UI object 702 indicating the device list is displayed by the generated UI component 401.

The UI component 401 controls the display of the UI object 702 by associating the customer information with the device information as described above with reference to FIG. 6, based on the customer information for which the notification was made by the web browser 304 (the website 307). The device list displayed as the UI object 702 displays the customer information the UI component 401 has been notified of and the device information associated with that customer information. In other words, the information, among the device information obtained by the UI component 401 from the device information management server 102, which is displayed in the device list is narrowed down based on the customer information for which the notification was made.

FIG. 7A illustrates an example of the display of the UI object 702 when the UI component 401 is notified of customer information, including management information corresponding to four devices having device names of “DeviceA” to “DeviceD”, by the web browser 304 (the website 307). As illustrated in FIG. 7A, the device list, displayed as the UI object 702 in the device list screen 701, includes items 703 and 704. The item 703 is an item corresponding to the customer information, and includes the name of the device (the device name), the installation location, and the serial number. The item 704 is an item corresponding to the device information, and includes the device's product name, serial number, status information (alert information), consumable information (toner remaining amount information), and security information.

The devices having device names of “DeviceA”, “DeviceB”, and “DeviceC”, shown in an area 705, are devices registered in the device information management server 102. In this case, the UI component 401 holds device information for those devices, obtained from the device information management server 102 and associated with the customer information. Therefore, as shown in the area 705, for each device, the customer information and the device information associated with that customer information are displayed on the UI object 702.

On the other hand, the device having a device name of “DeviceD”, shown in an area 706, is a device not registered in the device information management server 102. In this case, for that device, the UI component 401 does not hold device information associated with the customer information. Therefore, as shown in the area 706, device information is not displayed on the UI object 702 for the device having the device name of “DeviceD”, and only customer information is displayed.

FIG. 7B illustrates an example of the display of the UI object 702 when the UI component 401 is notified of customer information, including management information corresponding to a device having an installation location of “Building A/second floor”, by the web browser 304 (the website 307). In this example, the customer information of which the UI component 401 is notified is more limited than in the example in FIG. 7A. As a result, the device information associated with the notified customer information and displayed on the UI object 702 is narrowed down more than in the example in FIG. 7A. In this manner, based on the customer information the UI component 401 is notified of by the website 307, the device information displayed by the UI component 401 on the UI object 702 can be filtered (that is, the device information to be displayed on the UI object can be narrowed down).

As described above, in the information terminal 105 of the present embodiment, the web browser 304 displays the UI screen of the website 307 in the display device 208 based on the login to the website 307 provided by the customer information management server 103. In response to a user operation that instructs the device list screen (a first screen) to be displayed as the UI screen of the website 307, the web browser 304 makes a request to the UI component management server 101 for the UI component that displays a UI object in the device list screen. The web browser 304 obtains the UI component from the UI component management server 101 as a response to this request. The web browser 304 further obtains the customer information corresponding to the user logged into the website 307 from the customer information management server 103, to input to the UI component 401. The web browser 304 then displays the device list screen (the first screen) including the UI objects displayed by the UI component 401 in the display device 208. The UI component 401 is configured to request the device information provided by the device information management server 102 from the device information management server 102 and obtain that device information from the device information management server 102. Furthermore, based on one piece of information among the customer information obtained from the customer information management server 103 (the first information) and the device information (the second information) obtained from the device information management server 102 (the second server), the UI component 401 is configured to control the display of the other piece of the information on the UI object.

In this manner, in the present embodiment, the information terminal 105 obtains a UI component from the UI component management server 101 and incorporates the UI component into the website provided by the customer information management server 103. The information terminal 105 uses this UI component to obtain device information from the device information management server 102 and display the UI object in the device list screen (the first screen). Using the UI component in this manner makes it possible to lightening the burden of implementing a website for device management in the customer information management server 103. Additionally, based on one piece of information among the customer information obtained from the customer information management server 103 and the device information obtained from the device information management server 102 (the second server), the UI component controls the display of the other piece of the information on the UI object. The display of customer information and the display of device information are linked to each other in this manner. This makes it possible to efficiently display the customer information obtained from the customer information management server 103 (the first information) and the device information (the second information) obtained from the device information management server 102 (the second server).

As such, according to the present embodiment, information obtained from a plurality of servers can be displayed efficiently while lightening the burden of implementing a website for managing devices.

### Second Embodiment

The first embodiment described an example in which the UI component 401 controls the display of the device information (the second information) based on the customer information (the first information). In contrast, a second embodiment will describe an example in which the UI component 401 controls the display of the customer information (the first information) based on the device information (the second information). Descriptions of parts identical to those in the first embodiment will be omitted in the following.

<Processing Sequence>

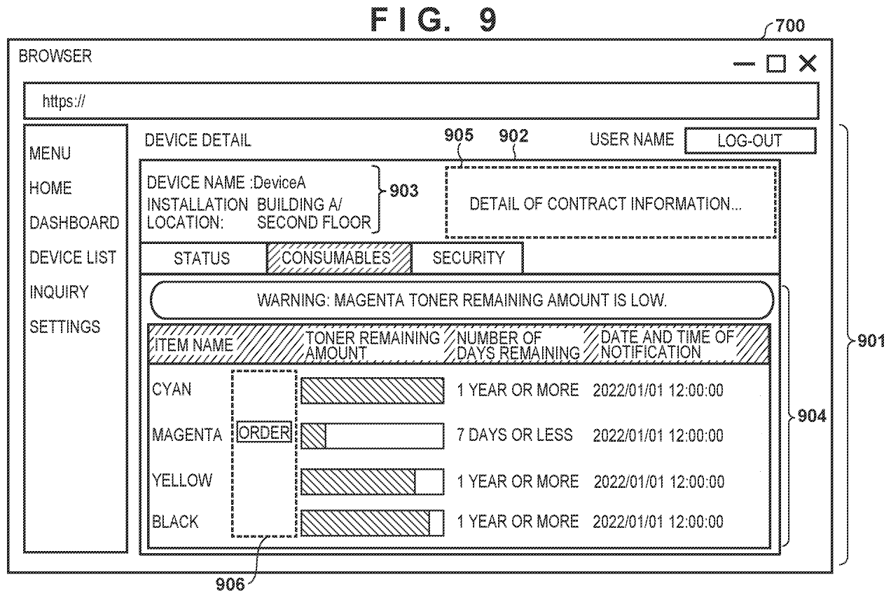

As in the first embodiment, processing is performed according to the sequence illustrated in FIG. 5 in the system according to the present embodiment. The present embodiment will describe an example in which after the login to the website 307 is complete, in step S505, the user makes an instruction to transition to a device details screen such as that illustrated in FIG. 9. The information terminal 105 (the web browser 304) accepts a user operation instructing the screen transition to the device details screen through the website screen displayed in the information terminal 105.

In response to the user operation for instructing the screen to transition to the device details screen, in step S506, the information terminal 105 (the web browser 304) makes a request to the UI component management server 101 for a UI component for displaying device details information. Upon receiving the request for the UI component from the web browser 304, the UI component management server 101 transmits the source code of the UI component, among the UI components which are managed, that has been requested to the web browser 304 as a response to the received request.

As a result, in step S507, the information terminal 105 (the web browser 304) obtains the source code of the UI component for displaying the device details information from the UI component management server 101. In step S508, the information terminal 105 (the web browser 304) generates the UI component 401 for displaying the device details information using the source code obtained in step S507. The generated UI component 401 runs in the web browser 304 (the website 307).

Then, when the obtainment of the customer information (steps S509 and S510) is completed, in step S511, the information terminal 105 (the web browser 304) notifies (inputs) the UI component 401 of the customer information required to use the UI component 401 (the necessary information), from among the obtained customer information. The following will describe an example of a part of the HTML, code used to notify (input to) the UI component 401 of the customer information in this example.

```
<ui-parts
          name = “device name”
          serial = “serial number”
          token = “authentication information”
>
    <div slot=“deviceInformation”>
        details of contract information...
  </div>
    <div slot=“cyanToner”>
        <button onclick=“cyanOrderClick( )”>
        order
      </button>
  </div>
    <div slot=“magentaToner”>
        <button onclick=“magentaOrderClick( )”>
        order
      </button>
  </div>
...
</ui-parts>
```

In the above-described example, as in the first embodiment, the device name, the serial number, and the authentication information of which the UI component 401 is notified as the customer information are written in the name attribute, the serial attribute, and the token attribute, respectively, of the original HTML tag (e.g., <ui-parts> . . . </ui-parts>). In this example, information indicating additional UI objects that are to be displayed on the UI object corresponding to the UI component 401 (additional UI information) is written in the child elements of the elements using the original HTML tag. Each child element has a slot attribute, and a slot name that is defined in advance on the UI component 401 side is written in the attribute value of the slot attribute. The slot name is associated with an area which is part of the UI object corresponding to the UI component 401, and where the additional UI object is displayed based on the information written in the child element (a slot area). In this manner, by writing the slot name defined in advance on the UI component 401 side in the slot attribute, the area where the additional UI object in question is displayed (the slot area) can be specified for the UI component 401 on the UI object corresponding to the UI component 401. The UI component 401 can also be notified of the additional UI information by the descriptions in the child elements described above.

Then, when the obtainment of the device information by the UI component 401 (steps S512 and S513) is complete, in step S514, the UI component 401 performs the display information determination processing for the UI object corresponding to that UI component. The UI component 401 determines the information to be displayed on the UI object based on the customer information notified (input) from the website 307 side and the device information obtained from the device information management server 102.

In this example, the UI component 401 determines the display information such that the additional UI objects based on the additional UI information for which the notification was made are arranged in the slot area specified as described above, on the corresponding UI object. The slot areas designated using slot names of “cyanToner”, “magentaToner”, “yellowToner”, and “blackToner” are used to display ordering buttons for the user to order toner containers, process cartridges, or the like as additional UI objects, based on the additional UI information. The UI component 401 controls the display of the ordering buttons (the additional UI objects) based on the device information obtained by the UI component 401 from the device information management server 102. For example, when the device information includes alert information indicating that the toner remaining amount is low, the UI component 401 controls the display of an ordering button as an additional UI object in the slot area on the UI object for the toner color indicated by the alert information.

<Display Information Determination Processing (Step S515)>

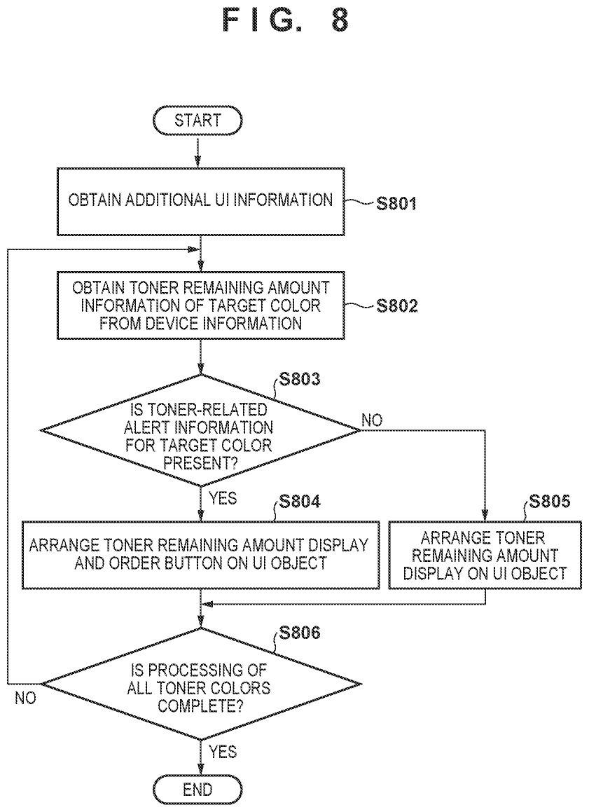

FIG. 8 is a flowchart illustrating an example of the sequence of the processing for determining display information for a UI object in the present embodiment (step S515). The processing in this sequence is executed by the UI component 401 for displaying the device details information running on the web browser 304 (the website 307) in the information terminal 105. The UI component 401 (the display information determining unit 408) performs the display information determination processing based on the customer information, including the additional UI information, notified (input) from the website 307 and the device information obtained from the device information management server 102.

In step S801, the UI component 401 obtains the additional UI information indicating additional UI objects to be displayed on the UI object corresponding to the UI component 401 through a notification (input) made by the website 307. The additional UI information is written, for example, as child elements of an element using the original HTML, tag indicating the generation of the UI component in the source code of website 307, as described above. Each child element is written using tags having slot attributes defined in advance for each toner color (cyanToner, magentaToner, yellowToner, and blackToner), and includes information for displaying the ordering button described above in the corresponding slot area based on the device information.

In step S802, the UI component 401 obtains the toner remaining amount information included in the device information obtained from the device information management server 102. If the toner remaining amount information includes information indicating the amount of toner remaining for a plurality of toner colors (cyan, magenta, yellow, and black) in the device in question, the UI component 401 obtains the toner remaining amount information for each of the plurality of toner colors, one color at a time, and performs the subsequent processing.

Next, in step S803, the UI component 401 determines whether toner-related alert information for the color in question is present in the device information. Here, the alert information is information that indicates the occurrence of alerts, such as jam-related alert information (the occurrence of a paper jam), toner-related alert information (that the toner remaining amount is low or there is no toner), and the like for each device.

If toner-related alert information for the target color is present, the UI component 401 moves the sequence to step S804, where a toner remaining amount display indicating the toner remaining amount information and an ordering button are arranged as the display information on the UI object corresponding to the UI component 401. The toner remaining amount display is arranged in a display area defined in advance on the UI component 401 side. The ordering button is generated in a display area defined in advance on the UI component 401 side (the slot area mentioned above), and is arranged in that display area. As a result, an ordering button is displayed for the color in question. On the other hand, if toner-related alert information for the target color is not present in step S803, the UI component 401 moves the sequence to step S805, where the toner remaining amount display is arranged as the display information on the UI object corresponding to the UI component 401. In this case, the display area for displaying the ordering button (the slot area described above) is not generated, and thus the ordering button is not displayed for the color in question.

After the processing in step S804 or step S805 is complete, in step S806, the UI component 401 determines whether the processing is complete for all of the plurality of toner colors. When the processing is complete for all the plurality of toner colors, the UI component 401 ends processing according to the sequence illustrated in FIG. 8, and returns to step S802 if there are any remaining toner colors for which the processing is not yet complete.

In this manner, based on the device information (the second information), the UI component 401 controls whether additional UI objects (ordering buttons) are displayed on the UI object based on the additional UI information. As a result, the user can ascertain which toner containers, process cartridges, or the like need to be replaced, and can immediately place an order.

### Example of Display of Device Details Screen

FIG. 9 illustrates a device details screen 901 as an example of the UI screen of the website 307 displayed by the web browser 304 in the information terminal 105. The device details screen 901 is displayed in a browser screen 700 of the web browser 304.

The web browser 304 accepts an instruction to display the device details screen (an instruction to transition to the device details screen) from the user through, for example, a UI screen of the website 307. The web browser 304 displays the device details screen 901 in the browser screen 700, including a UI object 902 indicating the device details information, in accordance with the instruction to display the device details screen.

The UI object 902 is a display object displayed by the UI component 401 for displaying the device details information. The UI component 401 to be implemented in the website 307 is generated based on the source code obtained from the UI component management server 101, and the UI object 902 indicating the device list is displayed by the generated UI component 401.

FIG. 9 illustrates an example of the display of the UI object 902 showing detailed information about a device having a device name of “DeviceA”. The UI object 902 includes an area 903 that displays the device name and the device installation location as the customer information, and an area 904 that displays the device information. The toner remaining amount and the number of days remaining until the toner runs out for each of the plurality of toner colors (cyan, magenta, yellow, and black) are displayed in the area 904 based on the toner remaining amount information included in the device information.

The UI object 902 further includes areas 905 and 906, which correspond to slot areas which are disposed on the UI object 902 and in which additional UI objects are displayed. The area 906 is arranged within the area 904. The additional UI objects are displayed based on the customer information (the additional UI information) which the UI component 401 is notified of by the web browser 304 (the website 307).

The area 905 corresponds to the slot area, among the slot areas disposed on the UI object 902, having a slot name of “deviceInformation”. The area 905 is configured to display additional customer information not defined in advance on the UI component 401 side, such as customer contract information and the like. The area 906 corresponds to the slot areas, among the slot areas disposed on the UI object 902, having slot names of “cyanToner”, “magentaToner”, “yellowToner”, and “blackToner”. An ordering button is disposed in the area 906 as an additional UI object based on the alert information which pertains to the toner remaining amount and which is included in the device information, according to the processing performed through the sequence illustrated in FIG. 8. In the display example in FIG. 9, an ordering button for ordering magenta toner is displayed in the area 906 based on alert information indicating that the magenta toner remaining amount is low.

As described above, in the information terminal 105 of the present embodiment, the UI component 401 controls the display of the customer information (the first information) based on the device information (the second information). The display of customer information and the display of device information are linked to each other in this manner. This makes it possible to efficiently display the customer information obtained from the customer information management server 103 (the first information) and the device information (the second information) obtained from the device information management server 102 (the second server).

### Third Embodiment

In the first and second embodiments, the customer information and the device information are arranged in different areas on the UI object displayed by the UI component 401. A third embodiment will describe an example in which the UI component 401 controls which of the customer information or the device information is displayed based on the customer information (the first information) and the device information (the second information), for each area in a figure or a table displayed on the corresponding UI object. The following will describe an example of displaying an inspection history of a target device based on history information included in each of the customer information and the device information in areas for each day on a calendar, displayed as a UI object indicating the detailed information of that device.

<Display Information Determination Processing (Step S515)>

FIG. 10 is a flowchart illustrating an example of the sequence of the processing for determining display information for a UI object in the present embodiment (step S515). The processing in this sequence is executed by the UI component 401 for displaying the device details information running on the web browser 304 (the website 307) in the information terminal 105.

In this example, the UI component 401 determines the display information for the UI object by generating calendar history data, which is used to display a calendar showing the inspection history of the target device as a UI object in the device details screen. The UI component 401 (the display information determining unit 408) performs the display information determination processing based on customer information notified from the website 307 (a history of onsite inspections and telephone support) and device information obtained from the device information management server 102 (a history of the operational status).

In step S1001, the UI component 401 generates the calendar history data for storing the information to be displayed on the corresponding UI object (the display information). As an example, the calendar history data is generated as data in list format for storing a history of the operational status, onsite inspections, and telephone support on each day for the target device.

Next, in step S1002, the UI component 401 obtains, from the customer information, the history information of onsite inspections and telephone support for the target device during a specified period (in this example, the calendar display period). The history information in configured as data in list format that holds the date and time on which an onsite inspection or telephone support was provided for the device. Furthermore, in step S1003, the UI component 401 obtains, from the device information, history information on the operational status of the target device for the specified period (in this example, the calendar display period). The history information in configured as data in list format holding alert information indicating the details and the dates and times of alerts occurring in the target device.

Then, in step S1004 to step S1009, the UI component 401 performs processing for determining the display information for each day on the calendar, as a processing target (a target date), for each day in the specified period (in this example, the calendar display period), and storing the display information in the calendar history data.

In step S1004, the UI component 401 determines whether alert information occurring on the target date is present in the device information obtained from the device information management server 102 as an operational status history. If the operational status history is present, the UI component 401 moves the sequence to step S1005, stores the operational status history in the calendar history data as data for the target date, and then moves the sequence to step S1007. On the other hand, if no operational status history is present, the UI component 401 moves the sequence to step S1006, stores data indicating that there are no device anomalies in the calendar history data as data for the target date, and then moves the sequence to step S1007.

In step S1007, the UI component 401 determines whether a history of onsite inspections or telephone support performed on the target date is present in the customer information for which the web browser 304 (website 307) made a notification. If no history of onsite inspections or telephone support performed on the target date is present, the UI component 401 moves the sequence to step S1009, whereas if a history of onsite inspections or telephone support performed on target date is present, the sequence moves to step S1008.

In step S1008, the UI component 401 stores the history of the onsite inspections or telephone support performed on the target date in the calendar history data as the data for the target date, and moves the sequence to step S1009. In step S1008, the UI component 401 overwrites the data for the target date stored in the calendar history data in step S1005 or step S1006. Through this, if no history of onsite inspections or telephone support performed on the target date is present in the customer information, information will be displayed in the area of the target date on the calendar based on the device information. On the other hand, if history of onsite inspections or telephone support performed on the target date is present in the customer information, information will be displayed in the area of the target date on the calendar based on the customer information.

In step S1009, the UI component 401 determines whether the processing is complete for all days in the specified period (in this example, the calendar display period). If the processing is not complete, the UI component 401 returns the sequence to step S1004 and continues processing from step S1004 onward, setting the next day in the specified period as the day to be processed (the target date). On the other hand, if the processing is complete, the processing of the sequence illustrated in FIG. 10 ends.

Through the above-described processing, the UI component 401 generates the calendar history data including the display information determined for the UI object (step S514). Based on the generated calendar history data, the UI component 401 displays the history information pertaining to the target device in calendar format on the UI object corresponding to the UI component 401 (step S515).

### Example of Display of Device Details Screen (Inspection History)

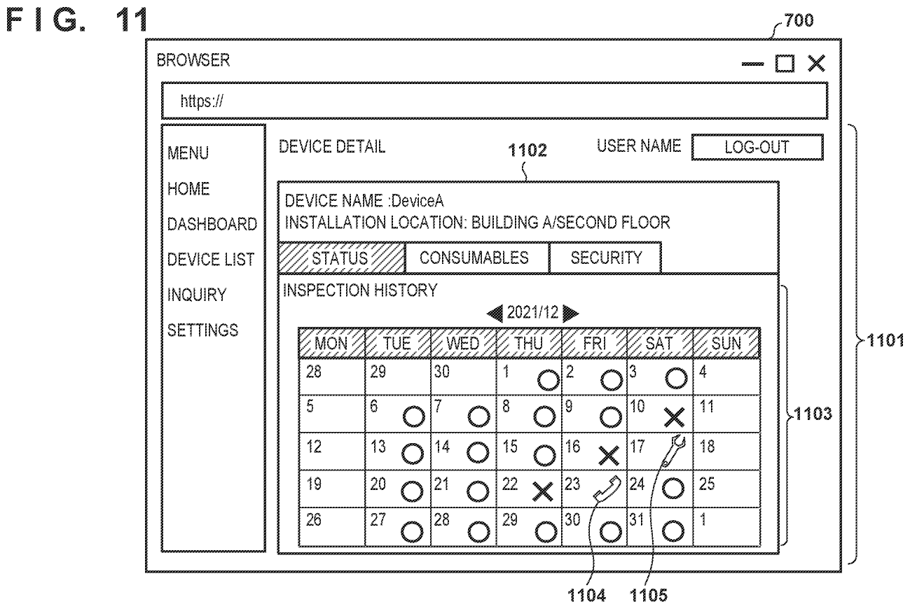

FIG. 11 illustrates a device details screen 1101, indicating an inspection history of a device, as an example of the UI screen of the website 307 displayed by the web browser 304 in the information terminal 105. The device details screen 1101 is displayed in a browser screen 700 of the web browser 304.

The web browser 304 accepts an instruction to display the device details screen (an instruction to transition to the device details screen) from the user through, for example, a UI screen of the website 307. The web browser 304 displays the device details screen 1101 including a UI object 1102 showing the device details information in the browser screen 700 in response to an instruction to display the device details screen.

The UI object 1102 is a display object displayed by the UI component 401 for displaying the device details information. The UI component 401 to be implemented in the website 307 is generated based on the source code obtained from the UI component management server 101, and a UI object 1102 indicating the device list is displayed by the generated UI component 401.

FIG. 11 illustrates an example of the display of the UI object 1102 showing detailed information about a device having a device name of “DeviceA”. The UI object 1102 includes a calendar display 1103 showing history information pertaining to the target device (an inspection history of the target device). Icons based on the customer information (a history of onsite inspections and telephone support) or the device information (a history of the operational status) are displayed in areas for each day in the calendar display 1103 on the UI object 1102.

The circle icon is displayed when, based on the device information, the device is operating normally and there are no anomalies in the device on the target date. The x icon is displayed when, based on the device information, there is an alert due to a device failure on the target date. An icon 1104 is displayed when, based on the customer information, telephone support was performed on the target date. An icon 1105 is displayed when, based on the customer information, an onsite inspection was performed on the target date.

In the example in FIG. 11, the UI component 401 controls which of the customer information (a history of onsite inspections and telephone support) and the device information (a history of the operational status) is displayed in the area for each day in the calendar display 1103 based on the customer information and the device information. Specifically, according to the sequence illustrated in FIG. if no history of onsite inspections or telephone support performed on the target date is present in the customer information, an icon based on the device information (the history of the operational status) will be displayed in the area of the target date on the calendar. On the other hand, if a history of onsite inspections or telephone support performed on the target date is present in the customer information, an icon based on that customer information will be displayed in the area of the target date on the calendar.

In this manner, the device information and the customer information can be displayed together in a figure or a table (the calendar display 1103, in this example) displayed on the UI object 1102. Such a display makes it possible to provide the user with more detailed history information about the device, such as, for example, that the device had a malfunction and that the malfunction was subsequently resolved by an onsite inspection or through telephone support.

As described above, in the present embodiment, the UI component 401 controls which of the customer information (the first information) or the device information (the second information) is displayed for each area in a figure or a table displayed on the corresponding UI object. This makes it possible to provide the user with more detailed history information pertaining to the device.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-088878, filed May 31, 2022, which is hereby incorporated by reference herein in its entirety.

What is claimed is:

1. An information processing apparatus capable of communicating with a server that provides a website for managing a specific device and with a system for providing information obtained by monitoring a plurality of devices including the specific device, the information processing apparatus comprising:
a first display unit configured to display, in a display unit of the information processing apparatus, the website provided by the server;
a first obtaining unit configured to obtain, from the system, a display program for displaying the information provided by the system on the website;
a second obtaining unit configured to obtain, by the display program, information on the specific device from the system using data which is data for accessing information on devices and which is data corresponding to a user who is logged into the website; and
a second display unit configured to display, by the display program, the information on the specific device in a predetermined screen that is a part of the website.

2. The information processing apparatus according to claim 1,
wherein the display program is implemented as JavaScript code for displaying the information provided by the system in the predetermined screen that is a part of the website.

3. The information processing apparatus according to claim 1,
wherein the display program is obtained from the system according to a description embedded in page information corresponding to the website, in response to a user operation made on the website.

4. The information processing apparatus according to claim 1,
wherein the data for accessing the information on the devices is obtained by making a request to the server after obtaining the display program.

5. The information processing apparatus according to claim 1,
wherein the data for accessing the information on the devices is an access token for accessing the information on the specific device managed by the system.

6. The information processing apparatus according to claim 1,
wherein the information on the specific device is operational information of the specific device.

7. The information processing apparatus according to claim 1,
wherein the information on the specific device is management information of a consumable of the specific device.

8. The information processing apparatus according to claim 1,
wherein the information on the specific device is information pertaining to security of the specific device.

9. A control method of an information processing apparatus capable of communicating with a server that provides a website for managing a specific device and with a system for providing information obtained by monitoring a plurality of devices including the specific device, the control method comprising:
displaying, in a display unit of the information processing apparatus, the website provided by the server;
obtaining, from the system, a display program for displaying the information provided by the system on the website;
obtaining, by the display program, information on the specific device from the system using data which is data for accessing information on devices and which is data corresponding to a user who is logged into the website; and
displaying, by the display program, the information on the specific device in a predetermined screen that is a part of the website.

10. A non-transitory computer-readable storage medium storing a program for causing a computer to execute a control method of an information processing apparatus capable of communicating with a server that provides a website for managing a specific device and with a system for providing information obtained by monitoring a plurality of devices including the specific device, the control method comprising:
displaying, in a display unit of the information processing apparatus, the website provided by the server;
obtaining, from the system, a display program for displaying the information provided by the system on the website;
obtaining, by the display program, information on the specific device from the system using data which is data for accessing information on devices and which is data corresponding to a user who is logged into the website; and
displaying, by the display program, the information on the specific device in a predetermined screen that is a part of the website.
